(19) United States
(12) Patent Application Publication
(10) Pub. No.: US 2013/0147725 A1
(43) Pub. Date: Jun. 13, 2013

(54) COMPREHENSIVE EYEGLASS DISPENSING ASSISTANCE SYSTEM

(71) Applicants: Ching-Chung CHU, Taipei (TW); Ching-Ming CHEN, Taoyuan (TW); Chun-Nung HUANG, New Taipei (TW); Chih-Hao HSIEH, New Taipei (TW); Chih-Hui WU, New Taipei (TW)

(72) Inventors: Ching-Chung CHU, Taipei (TW); Ching-Ming CHEN, Taoyuan (TW); Chun-Nung HUANG, New Taipei (TW); Chih-Hao HSIEH, New Taipei (TW); Chih-Hui WU, New Taipei (TW)

(21) Appl. No.: 13/486,557

(22) Filed: Jun. 1, 2012

(30) Foreign Application Priority Data
Dec. 9, 2011 (TW) 100145588

(51) Int. Cl. G06F 3/01; G06F 3/041; G06T 13/00

(52) U.S. Cl. 345/173; 345/156

(57) ABSTRACT

A comprehensive eyeglass dispensing assistance system includes an input device, a data storage device and a display device respectively electrically coupled to a processor, which receives an inputted instruction signal from the input device to fetch corresponding eyeglass dispensing desktop data and eyeglass wearing simulation animation data from the data storage devices for display on a menu directory zone and a condition indicator zone on the screen of the display device so that the consumers can understand and judge the symptoms and reasons of their vision acuity and the type or kind of corrective eyeglasses to be selected, facilitating optometric procedure explanation and performance.

### BACKGROUND OF THE INVENTION

The present invention is related to eyeglass dispensing technology and more particularly, to a comprehensive eyeglass dispensing assistance system, which enables the consumers to understand and judge the symptoms and reasons of their vision acuity and the type or kind of corrective eyeglasses to be selected, facilitating optometric procedure explanation and performance.

When the vision becomes poor, people may visit an ophthalmology clinic or optical store to examine the vision, requesting for an optometric procedure for vision correction. An ophthalmologist or optician will use various properties to inquire or examine the patient's vision, determining the factor for vision impairment to be myopia, hyperopia, glaucoma or presbyopia. Subject to the eye symptoms examined, the ophthalmologist or optician suggests the patient to wear the correct type of eyeglasses that correct or improve the vision.

During a conventional optometric procedure, an ophthalmologist or optician needs to use various properties and books, or to orally describe various conditions, enabling the patient to understand different visual impairment symptoms or factors that cause formation of visual impairment. This optometric procedure is complicated. Because a patient cannot imagine the outside world he(she) can see when wearing a pair of corrective eyeglasses, he(she) cannot soon decide which kind of corrective lenses to buy. Taking presbyopia for example, there are many kinds of corrective lenses available for choice, such as single vision lens, bifocal lens and progressive multifocal lens. To a patient, it is difficult to experience the differences between lenses.

### SUMMARY OF THE PRESENT INVENTION

It is, therefore, the main object of the present invention to provide a comprehensive eyeglass dispensing assistance system, which enables visual acuity impact symptoms or kinds of eyeglasses to wear to be actively displayed on a display device in the form of animation images, so that a commentator can make presentation in front of the patient easily and the patient can know the symptoms of his (her) eyes and select suitable corrective eyeglasses, facilitating the performance of the optometric procedure and saving much eyeglass dispensing explanation time.

It is another object of the present invention to provide a comprehensive eyeglass dispensing assistance system, which enables all eyeglass dispensing related data or conditions to be displayed on a display screen of a mobile electronic device or tablet computer, facilitating the user to make a presentation to the patient to explain the eye symptoms or kinds of lenses at any time and any place and saving paper waste.

It is still another object of the present invention to provide a comprehensive eyeglass dispensing assistance system, which is integrated into a mobile electronic device having built therein a position sensor, wherein the position sensor senses forward/backward displacement position of the display screen of the mobile electronic device, causing a corresponding eyeglass wearing simulation data or eyeglass wearing simulation animation data to be displayed on the display screen. Subject to interaction relationship between the patient and the eyeglass wearing simulation data, the comprehensive eyeglass dispensing assistance system increases the patient's interest to wear a pair of corrective eyeglasses and enhances corrective eyeglass selection convenience.

The present invention provides a comprehensive eyeglass dispensing assistance system, comprising: an input device for inputting an instruction signal; a data storage device having stored therein at least one eyeglass dispensing desktop data and a plurality of eyeglass wearing simulation data; a display device comprising a menu directory zone adapted for displaying said at least one eyeglass dispensing desktop data and a condition indicator zone adapted for displaying said eyeglass wearing simulation data; and a processor electrically coupled with said input device, said data storage device and said display device for receiving an instruction signal from said input device and fetching the corresponding eyeglass dispensing desktop data and eyeglass wearing simulation data from said data storage devices subject to the received instruction signal and then transmitting the fetched data to said display device for display.

In one embodiment of the present invention, wherein said menu directory zone of said display device comprises a plurality of condition options, each said condition option corresponding to at least one said eyeglass wearing simulation data.

In one embodiment of the present invention, wherein each said condition option comprises a plurality of position options, each said position option corresponding to one said eyeglass wearing simulation data.

In one embodiment of the present invention, wherein said input device has built therein a position sensor adapted for sensing forward/backward displacement position of said input device corresponding to one said eyeglass wearing simulation data.

In one embodiment of the present invention, wherein said menu directory zone comprises at least one outline item and a plurality of bottom layer items.

In one embodiment of the present invention, wherein said condition indicator zone comprises a lens visible area.

In one embodiment of the present invention, wherein each said eyeglass wearing simulation data is an eyeglass wearing simulation animation data.

In one embodiment of the present invention, wherein said input device and said display device are integrated into a touchscreen.

In one embodiment of the present invention, wherein input device, said data storage device, said display device and said processor are integrated into a mobile electronic device.

In one embodiment of the present invention, wherein said mobile electronic device is a tablet computer.

### BRIEF DESCRIPTION OF THE DRAWINGS

FIG. 1 is a schematic drawing illustrating a comprehensive eyeglass dispensing assistance system in accordance with a first embodiment of the present invention.

FIG. 2 is a schematic drawing illustrating a comprehensive eyeglass dispensing assistance system in accordance with a second embodiment of the present invention.

FIG. 3 is a schematic drawing illustrating a comprehensive eyeglass dispensing assistance system in accordance with a third embodiment of the present invention.

FIG. 4 is a schematic drawing illustrating a comprehensive eyeglass dispensing assistance system in accordance with a fourth embodiment of the present invention.

FIG. 5 is a schematic drawing illustrating a comprehensive eyeglass dispensing assistance system in accordance with a fifth embodiment of the present invention.

### DETAILED DESCRIPTION OF THE PREFERRED EMBODIMENTS

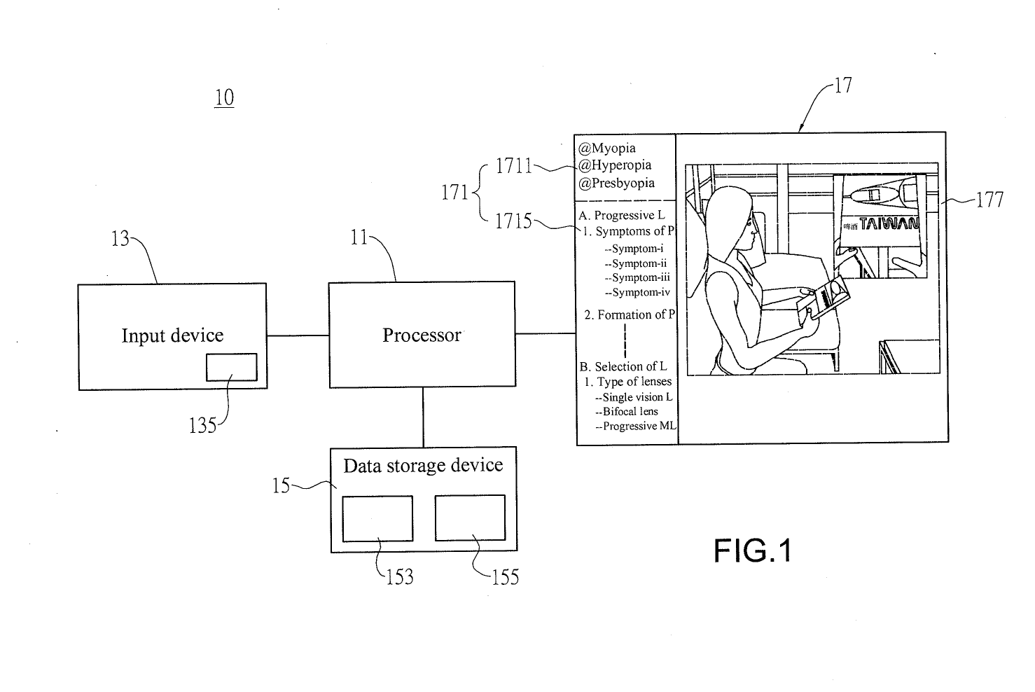

Please refer to FIG. 1, a comprehensive eyeglass dispensing assistance system in accordance with a first embodiment of the present invention is shown. The comprehensive eyeglass dispensing assistance system 10 comprises a processor 11, an input device 13, a data storage device 15, and a display device 17. The input device 13, the data storage device 15 and the display device 17 are respectively electrically connected to the processor 11.

The input device 13 is operable to input an instruction signal 135 and to transmit the instruction signal 135 to the processor 11. Subject to the instruction signal 135, the processor 11 fetches a corresponding eyeglass dispensing desktop data 153 and/or eyeglass wearing simulation data 155 from the data storage device 15, and then displays the fetched eyeglass dispensing desktop data 153 and/or eyeglass wearing simulation data 155 on the display device 17. The display device 17 comprises a menu directory zone 171 and a condition indicator zone 177. The eyeglass dispensing desktop data 153 fetched from the data storage device 15 will be displayed on the menu directory zone 171. The eyeglass wearing simulation data 155 fetched from the data storage device 15 will be displayed on the condition indicator zone 177.

When a patient visits an ophthalmology clinic or optical store to examine the vision, the ophthalmologist, nurse or dispensing optician can then turn on the comprehensive eyeglass dispensing assistance system 10 for the patient to view. From the menu directory zone 171 of the display device 17, the patient can view the eyeglass dispensing desktop data 153, which contains the title or directory of different items of data, such as common sense to wear eyeglasses, symptom, vision correction optical diagram and/or kind of corrective spectacle lenses. By means of the input device 13 to select or click one specific item 1711 or 1715 from the menu directory zone 171, the eyeglass wearing simulation data 155 corresponding to the specific item 1711 or 1715 on the menu directory zone 171 is then displayed on the condition indicator zone 177. It is to be understood that when the comprehensive eyeglass dispensing assistance system 10 is turned on, an eyeglass dispensing desktop data 153 and an eyeglass wearing simulation data 155 will respectively appear on the menu directory zone 171 and condition indicator zone 177 of the display device 17.

In this first embodiment, the eyeglass dispensing desktop data 153 to be displayed on the menu directory zone 171 of the display device 17 includes outline items 1711 of myopia (nearsightedness), hyperopia (farsightedness), glaucoma and/or presbyopia, and bottom layer items 1715 of symptom, symptom formation diagram (eye image), kind of corrective spectacle lenses and/or comparison of corrective spectacle lenses at the bottom side of the outline items 1711.

Taking the outline item 1711 of presbyopia for example, when the user inputs an instruction signal 135 into the input device 13 to select “presbyopia”, a series of bottom layer items 1715 will appear for selection, which include presbyopia symptom-1, presbyopia symptom-2, presbyopia symptom-3, presbyopia symptom-4, formation of presbyopia, single vision reading lens, bifocal reading lens, progressive reading glasses, multipurpose multifocal lens, multifocal lens general comparison, (condition) comparison, eye movement difference, comparison of reading posture, comparison of near visual field, wavefront technology, comparison of progressive multifocal lenses for small eyeglass frame, notes (eyeglass dispensing), notes for up-down eye movement, notes for left-right eye movement, notes for using staircase, notes for wearing eyeglasses, lens selection, lens coating, anti-glare lenses, anti-oil lenses, wear-resistant lenses, anti-dust glasses, water-repellent lenses, polarized lenses, photochromic lenses, special feature lenses, myopia progression retarding lenses, relaxation lenses, single-vision lenses, spherical single-vision lenses, aspherical single-vision lenses, comparison of reading area, comparison of peripheral distortion, and/or comparison of optical performance. An eyeglass wearing simulation data 155 corresponding to each outline item 1711 or bottom layer items 1715 is stored in the data storage device 15 in the form of a simulation diagram, film or picture for explanation.

Following the sequence of the optometric procedure, the patient (consumer) can understand the symptoms and reasons of his (her) vision acuity and the type or kind of corrective eyeglasses to be selected. Subject to the assistance of the comprehensive eyeglass dispensing assistance system 10, the optometric procedure can easily be performed, saving much eyeglass dispensing explanation time.

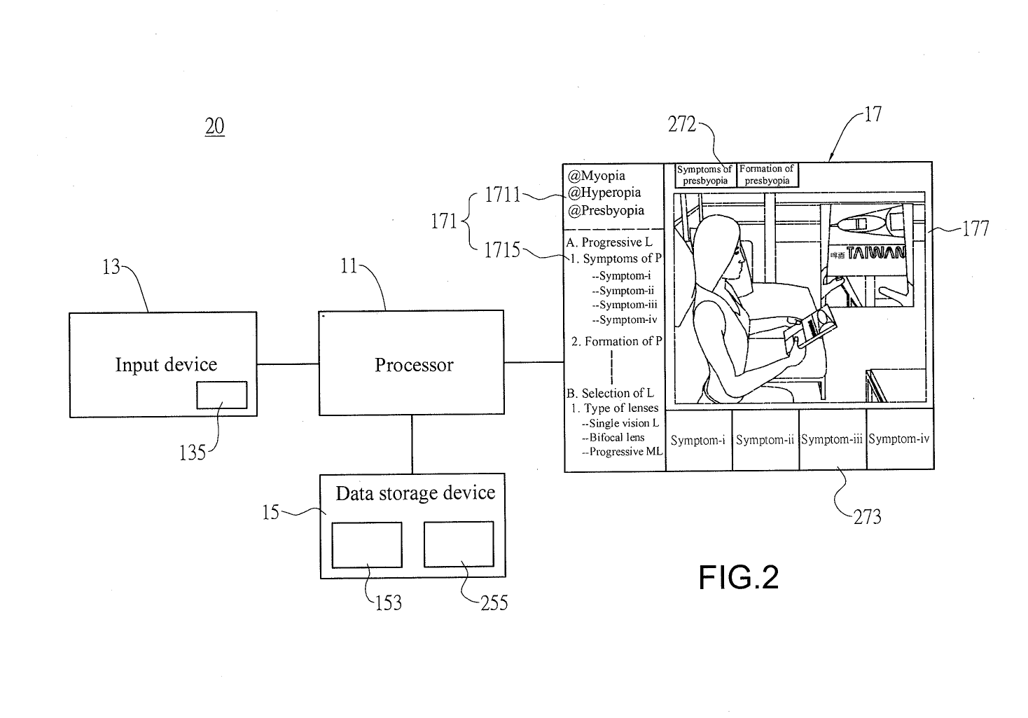

FIG. 2 illustrates a comprehensive eyeglass dispensing assistance system in accordance with a second embodiment of the present invention. According to this second embodiment, the display device 17 of the comprehensive eyeglass dispensing assistance system 20 further comprises a plurality of condition options 273 and/or at least one menu indicator zone 272. This second embodiment alter a part of the bottom layer items 1715 in the menu directory zone 171 of the aforesaid first embodiment shown in FIG. 1, and have it be presented in the condition options 273 and/or at least one menu indicator zone 272, showing a layered menu design to facilitate commentator's explanation and to let the patient (consumer) fully understand the explanation.

As illustrated in FIG. 2, the outline item “presbyopia” 1711 appears in the menu directory zone 171; “presbyopia symptoms” and “formation of presbyopia” appear in the menu indicator zone 272; “symptom-i”, “symptom-ii”, “symptom-iii”, “symptom-iv” corresponding to “presbyopia symptoms” appear in the condition options 273. “presbyopia symptoms”, “formation of presbyopia”, “symptom-i”, “symptom-ii”, “symptom-iii” and “symptom-iv” all pertain to contents of the bottom layer items 1715.

When the patient (consumer) operates the input device 13 to input “presbyopia symptoms”, “symptom-i”, “symptom-ii”, “symptom-iii” and “symptom-iv” will be immediately presented in the condition options 273, and a diagram, film or picture of eyeglass wearing simulation data 155 corresponding to “symptom-i” will be presented in the condition indicator zone 177 of the display device 17.

The diagram of eyeglass wearing simulation data 155 corresponding to “symptom-I” can indicate: “when books and newspaper fonts cannot be seen clearly at a normal reading distance (for example, 30˜40 cm) and must be moved to a greater distance for clear reading, it means a visual impairment and presbyopia symptoms have appeared”.

When clicks “symptom-iv”, a diagram, film or picture of eyeglass wearing simulation data 155 corresponding to “symptom-iv” is immediately presented in the condition indicator zone 177 of the display device 17. The diagram for “symptom-iv” indicates: “when wearing a pair of farsighted corrective eyeglasses cannot see books and newspaper fonts clearly and the fonts can be seen clearly after removal of the eyeglasses, it means the symptoms of presbyopia are apparent and wearing of a pair of reading eyeglasses is necessary”.

When clicking “symptom-i”, “symptom-ii”, “symptom-iii” and “symptom-iv” properly and check the corresponding diagrams, films or pictures of eyeglass wearing simulation data 155, the patient can easily understand or judge the degree of his(her) vision impairment and the type of corrective eyeglasses to wear.

To facilitate understanding of the content of the optometric procedure, the eyeglass wearing simulation data 155 can be an eyeglass wearing simulation animation data 255. Matching with the outline item 1711, the bottom layer items 1715, the condition options 273 or the menu indicator zone 272, the eyeglass wearing simulation animation data 255 is presented in animated video to actively express the content of the optometric procedure.

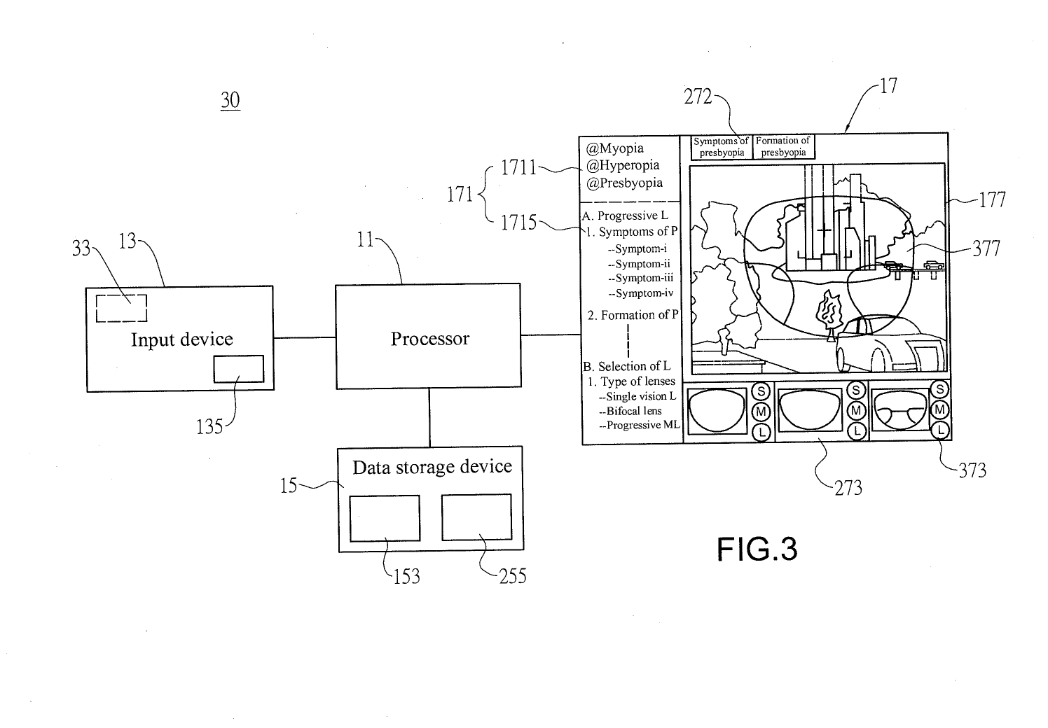

FIG. 3 illustrates a comprehensive eyeglass dispensing assistance system 30 in accordance with a third embodiment of the present invention. According to this third embodiment, each condition option 273 of comprehensive eyeglass dispensing assistance system 30 comprises a plurality of position options 373, for example, “long distance”, “medium distance” and/or “short distance”. When clicking the position option 373 of “long distance”, “medium distance” or “short distance”, a corresponding eyeglass wearing simulation animation data 255 or eyeglass wearing simulation data 155 will appear in the condition indicator zone 177 of the display device 17, simulating the picture of the outside world can be seen with the corrective eyeglasses.

In this third embodiment, the condition indicator zone 177 comprises therein a lens visible area 377, which, matching with the position option 373 of “long distance”, “medium distance” or “short distance”, simulates the picture of the outside world the patient can see through the corrective eyeglasses. For example, as shown in FIG. 3, assume the patient wears a pair of progressive multifocal eyeglasses, the simulated picture appears: “the upper block of the progressive multifocal eyeglasses can see clearly long distance images; the middle block of the progressive multifocal eyeglasses can see clearly medium distance images; the lower block of the progressive multifocal eyeglasses can see clearly short distance images; the opposing left and right blocks of the progressive multifocal eyeglasses will appear unclear images.

In this third embodiment, the condition indicator zone 177 comprises therein a lens visible area 377, which, in conjunction with the option of “long distance”, “medium distance” or “short distance” from the position options 373,

In this third embodiment, the input device 13 has built therein a position sensor 33. Subject to forward and backward displacement of the input device 13, selection of “long distance”, “medium distance” or “short distance” is determined, and the corresponding eyeglass wearing simulation animation data 255 or eyeglass wearing simulation data 155 is displayed.

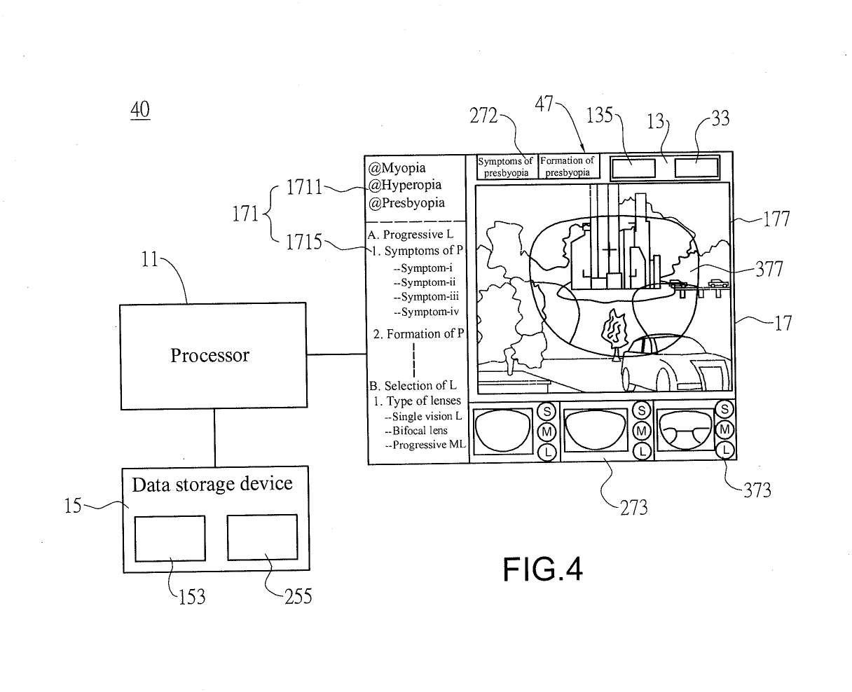

FIG. 4 illustrates a comprehensive eyeglass dispensing assistance system 40 in accordance with a fourth embodiment of the present invention. According to this fourth embodiment, the input device 13 and the display device 17 are integrated into a touchscreen 47. An instruction signal 135 can be inputted into the input device 13 and/of position sensor 33 can be give directly through the touchscreen 47, facilitating the operation and use of the comprehensive eyeglass dispensing assistance system 40.

In the embodiment shown in FIG. 4, the processor 11 is electrically coupled with the touchscreen 47 by a physical line. Alternatively, a well-supported wireless interface means can be used for communication between the processor 11 and the touchscreen 47 in a wireless manner.

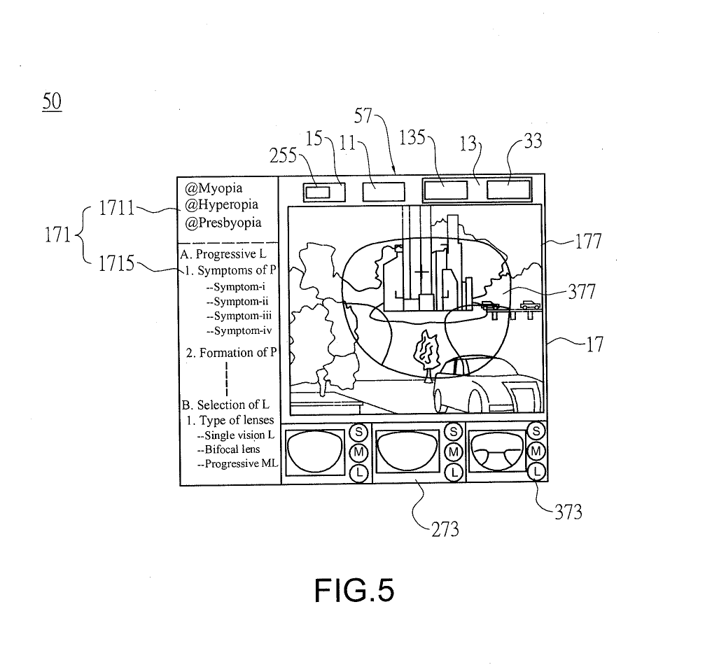

FIG. 5 illustrates a comprehensive eyeglass dispensing assistance system 50 in accordance with a fifth embodiment of the present invention. According to this fifth embodiment, the processor 11, the input device 13, the data storage device 15 and the display device 17 are integrated into a mobile electronic device 57 that can be a smart phone, a mobile cell phone, GPS navigator, mobile multimedia TV, PDA (personal digital assistant), notebook computer, or tablet computer.

A tablet computer 57 is the best tool to carry the comprehensive eyeglass dispensing assistance system 50. When the mobile electronic device is equipped with the position sensor 33, the user can give an instruction signal 135 and alter the eyeglass wearing simulation animation data 255 simply by moving the tablet computer 57, facilitating carrying out the eyeglass dispensing procedure.

The foregoing description is merely one embodiment of the present invention and not considered as restrictive. All equivalent variations and modifications in shape, structure, feature, and spirit in accordance with the appended claims may be made without in any way from the scope of the invention.

What is claimed is:

1. A comprehensive eyeglass dispensing assistance system, comprising:
an input device for inputting an instruction signal;
a data storage device having stored therein at least one eyeglass dispensing desktop data and a plurality of eyeglass wearing simulation data;
a display device comprising a menu directory zone adapted for displaying said at least one eyeglass dispensing desktop data and a condition indicator zone adapted for displaying said eyeglass wearing simulation data; and
a processor electrically coupled with said input device, said data storage device and said display device for receiving an instruction signal from said input device and fetching the corresponding eyeglass dispensing desktop data and eyeglass wearing simulation data from said data storage devices subject to the received instruction signal and then transmitting the fetched data to said display device for display.

2. The comprehensive eyeglass dispensing assistance system as claimed in claim 1, wherein said menu directory zone of said display device comprises a plurality of condition options, each said condition option corresponding to at least one said eyeglass wearing simulation data.

3. The comprehensive eyeglass dispensing assistance system as claimed in claim 1, wherein each said condition option comprises a plurality of position options, each said position option corresponding to one said eyeglass wearing simulation data.

4. The comprehensive eyeglass dispensing assistance system as claimed in claim 1, wherein said input device has built therein a position sensor adapted for sensing forward/backward displacement position of said input device corresponding to one said eyeglass wearing simulation data.

5. The comprehensive eyeglass dispensing assistance system as claimed in claim 1, wherein said menu directory zone comprises at least one outline item and a plurality of bottom layer items.

6. The comprehensive eyeglass dispensing assistance system as claimed in claim 1, wherein said condition indicator zone comprises a lens visible area.

7. The comprehensive eyeglass dispensing assistance system as claimed in claim 1, wherein each said eyeglass wearing simulation data is an eyeglass wearing simulation animation data.

8. The comprehensive eyeglass dispensing assistance system as claimed in claim 1, wherein said input device and said display device are integrated into a touchscreen.

9. The comprehensive eyeglass dispensing assistance system as claimed in claim 1, wherein input device, said data storage device, said display device and said processor are integrated into a mobile electronic device.

10. The comprehensive eyeglass dispensing assistance system as claimed in claim 9, wherein said mobile electronic device is a tablet computer.

11. The comprehensive eyeglass dispensing assistance system as claimed in claim 2, wherein each said eyeglass wearing simulation data is an eyeglass wearing simulation animation data.

12. The comprehensive eyeglass dispensing assistance system as claimed in claim 3, wherein each said eyeglass wearing simulation data is an eyeglass wearing simulation animation data.

13. The comprehensive eyeglass dispensing assistance system as claimed in claim 4, wherein each said eyeglass wearing simulation data is an eyeglass wearing simulation animation data.

14. The comprehensive eyeglass dispensing assistance system as claimed in claim 2, wherein said input device and said display device are integrated into a touchscreen.

15. The comprehensive eyeglass dispensing assistance system as claimed in claim 4, wherein said input device and said display device are integrated into a touchscreen.

16. The comprehensive eyeglass dispensing assistance system as claimed in claim 2, wherein input device, said data storage device, said display device and said processor are integrated into a mobile electronic device.

17. The comprehensive eyeglass dispensing assistance system as claimed in claim 4, wherein input device, said data storage device, said display device and said processor are integrated into a mobile electronic device.
